(19) United States
(12) Patent Application Publication
(10) Pub. No.: US 2008/0086627 A1
(43) Pub. Date: Apr. 10, 2008

(54) METHODS AND APPARATUS TO ANALYZE COMPUTER SOFTWARE

(76) Inventors: Steven John Splaine, Tampa, FL (US); Alan Lee White, Odessa, FL (US)

Correspondence Address: HANLEY, FLIGHT & ZIMMERMAN, LLC, 150 S. WACKER DRIVE, SUITE 2100, CHICAGO, IL, 60606, US

(21) Appl. No.: 11/877,777

(22) Filed: Oct. 24, 2007

Related U.S. Application Data
(63) Continuation of application No. PCT/US06/61448, filed on Dec. 1, 2006.
(60) Provisional application No. 60/828,430, filed on Oct. 6, 2006.

(51) Int. Cl. G06F 3/048; G06F 9/30

(52) U.S. Cl. 712/227; 715/780

(57) ABSTRACT

Methods and apparatus to analyze computer software are disclosed. The disclosed methods and apparatus may be used to verify and validate computer software. An example method includes receiving from a software test engine a definition of a graphical user interface associated with an application, receiving a user input indicating a test instruction associated with the graphical user interface associated with the application, generating a test engine independent file including a first identifier associated with the graphical user interface associated with the application and a second identifier associated with the test instruction, reading the first identifier and the second identifier from the test engine independent file, and causing the software test engine to perform the test instruction associated with the second identifier using the first identifier.

### RELATED APPLICATIONS

This patent claims the benefit of U.S. Provisional Patent Application No. 60/828,430, filed Oct. 6, 2006, entitled “METHODS AND APPARATUS TO ANALYZE COMPUTER SOFTWARE,” and International Application No. PCT/US06/61448, filed Dec. 1, 2006, entitled “METHODS AND APPARATUS TO ANALYZE COMPUTER SOFTWARE” which is hereby incorporated by reference in their entirety.

### FIELD OF THE DISCLOSURE

This disclosure relates generally to computer software and, more particularly, to analysis and validation of computer software.

### BACKGROUND

Software applications are typically reviewed for accuracy many times before they are released. One method for testing software involves using automated testing techniques to verify that the software operates properly (e.g., according to specified requirements or specifications). In automated testing, a computer is provided with instructions indicating how to perform tests and sample arguments for performing those tests. The computer performs the tests using the arguments and reports the results. For example, validation of a particular graphical user interface may require that each of a plurality of options in a menu be selected. Rather than having a person manually select each option, a computer performing automated testing can select each option and return a spreadsheet with the results (e.g., a report of which functionality worked and which functionality did not).

### BRIEF DESCRIPTION OF THE DRAWINGS

FIG. 1 is a block diagram of an example system to analyze computer software.

FIG. 2 is a block diagram of an example implementation of the test creator of FIG.

FIG. 3 is a flowchart representative of an example process that may be performed to implement the example system of FIG. 1.

FIG. 4 is a flowchart representative of an example process to publish test assets.

FIG. 5 is a flowchart representative of an example process to execute published test assets.

FIG. 6 illustrates examples of the one or more published test assets of FIG. 1.

FIG. 7 illustrates example machine readable instructions that may be used to implement the example main loop of the test executor of FIG. 1 and/or the example process of FIG. 5.

FIG. 8 illustrates example machine readable instructions that may be used to implement the example function library of the test executor of FIG. 1.

FIG. 9 illustrates an example data model to implement the test creator data store of FIG. 2.

FIG. 10 illustrates an example screen and component maintenance form graphical user interface for the test creator of FIG. 1.

FIG. 11 illustrates an example control and action maintenance form graphical user interface for the test creator of FIG. 1.

FIG. 12 illustrates an example test step creation form graphical user interface for the test creator of FIG. 1.

FIG. 13 illustrates a first example test case wizard graphical user interface for the test creator of FIG. 1.

FIG. 14 illustrates a second example test case wizard graphical user interface for the test creator of FIG. 1.

FIG. 15 illustrates an example test suite creation form graphical user interface for the test creator of FIG. 1.

FIG. 16 illustrates an example impact analyzer graphical user interface for the test creator of FIG. 1.

FIG. 17 illustrates an example user manager graphical user interface for the test creator of FIG. 1.

FIG. 18 is a block diagram of an example computer that may execute machine readable instructions to implement the example processes illustrated in FIGS. 3, 4, and 5.

### DETAILED DESCRIPTION

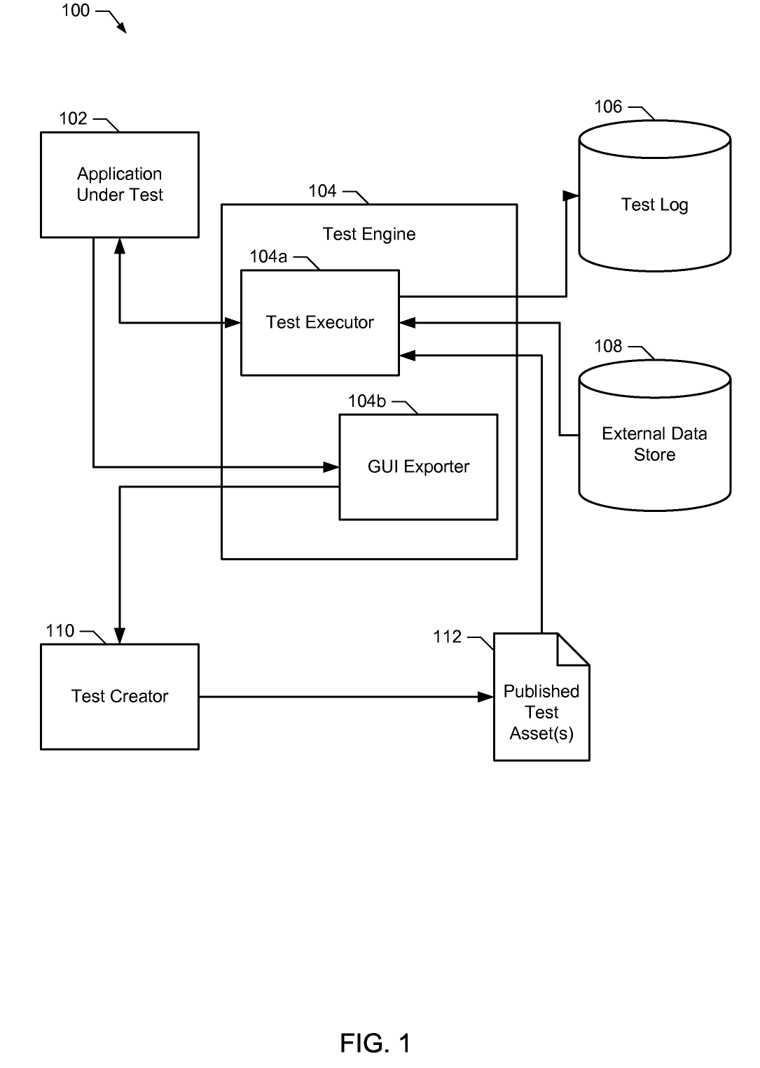

FIG. 1 is a block diagram of an example system 100 to analyze computer software. In general, the example system 100 allows a user to create software tests and to execute the software tests to validate a software application. In an example implementation, a description is generated for a graphical user interface associated with an application to be tested. The example system 100 provides a subject user interface for a user to input information regarding tests that are to be performed on the graphical user interface. The information pertaining to the tests is then output in a test engine independent file (e.g., a file that is not proprietary to a single test engine, a file that can be read by multiple test engines, etc.). A software test engine then reads the test engine independent file and parses through the information about tests contained in the file. The software test engine performs the tests on the graphical user interface and outputs the results of the performed tests. A single implementation of the example system 100 may be used with a variety of test engines because the information regarding tests is output in a test engine independent file.

The example system 100 includes an application under test (AUT) 102, a test engine 104, a test log 106, an external database 108, a test creator 110, and a published test asset 112.

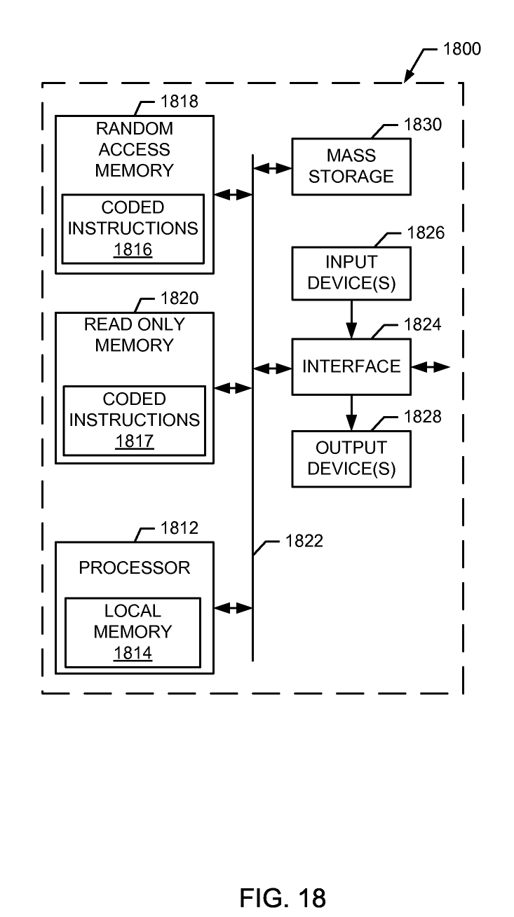

The AUT 102 of the illustrated example is a software application having a graphical user interface (GUI) that is to be validated by the methods and apparatus described herein. The GUI of the AUT 102 allows a user of the AUT 102 to interact (e.g., submit information, request data, etc.) with the AUT 102. In the example system 100, the AUT 102 is run by a computer (e.g., the computer 1800 of FIG. 18). For example, the AUT 102 may be a software application that allows a user of the AUT 102 to authenticate themselves to a computer system (e.g., using a username and a password). The AUT 102 may alternatively be any type of software application. Alternatively, the AUT 102 may not include a GUI. For example, the AUT 102 may have a voice activated user interface, a command line interface (CLI), or any other type of user interface. Further, the AUT 102 may be implemented using computer instructions that have not been compiled such as, for example, JAVA computer instruction, C/C+/C# computer instructions, hypertext markup language (HTML) instructions, Visual Basic computer instructions, computer instructions associated with the .Net platform, PowerBuilder computer instructions, practical extraction and reporting language (PERL) instructions, Python computer instructions, etc.

The test engine 104 is a software application or collection of software applications for interacting with other software applications such as, for example, the AUT 102. The test engine 104 of the illustrated example is a software test automation tool. In other words, the test engine 104 receives test scripts defining one or more desired tests to be run on the AUT 102, executes those test scripts, and outputs the results of the test scripts. The test engine 104 may be, for example, Rational® Robot from IBM®, Mercury QuickTest Professional™, Borland SilkTest®, Ruby Watir, IBM® Rational Functional Tester, Mercury™ WinRunner™, etc. Alternatively, the test engine 104 may be any other software application or collection of software applications that is capable of interacting with the AUT 102.

The example test engine 104 includes a test executor 104a and a GUI exporter 104b. The test executor 104a of the illustrated example interacts with the AUT 102 to test the AUT 102. In one example, test executor 104a is a set of computer instructions that read the test enumerated in the one or more published test assets(s) and call the appropriate functions of the test engine 104 to cause the test engine 104 to interact with and validate the AUT 102. The example test executor 104a receives data that may be used in performing tests from the external data store 108. For example, when validating the authentication capabilities of the example AUT 102, the test executor 104a retrieves from the external data store 108 a list of usernames and passwords to test on the AUT 102. As the example test executor 104a performs its testing functions, the example test executor 104a stores the results of tests performed on the AUT 102 in the test log 106.

The example test executor 104a may be implemented in a number of different ways. For example, the example test executor 104a may be an integrated part of the test engine 104, a standalone application, or an application that interacts with the test executor.

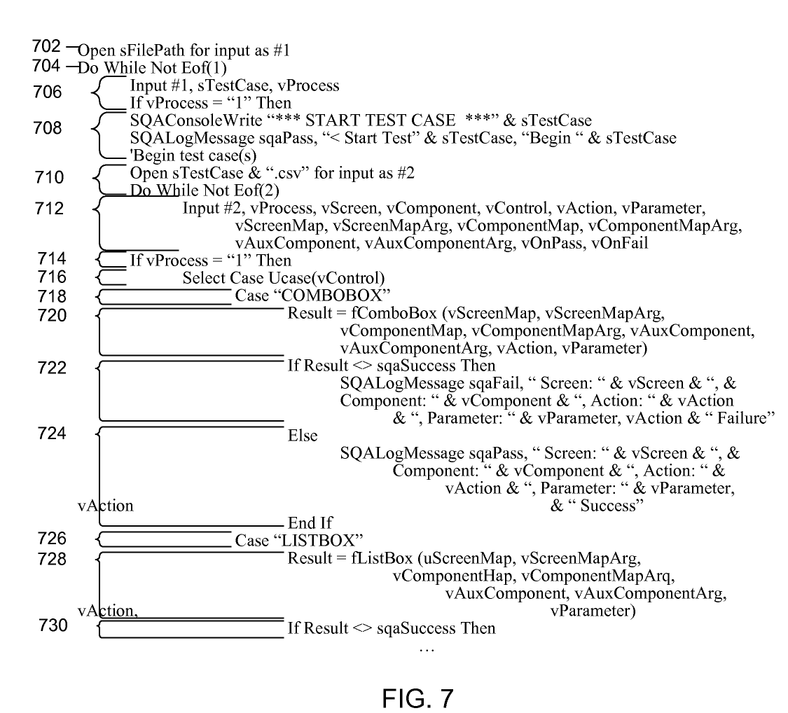

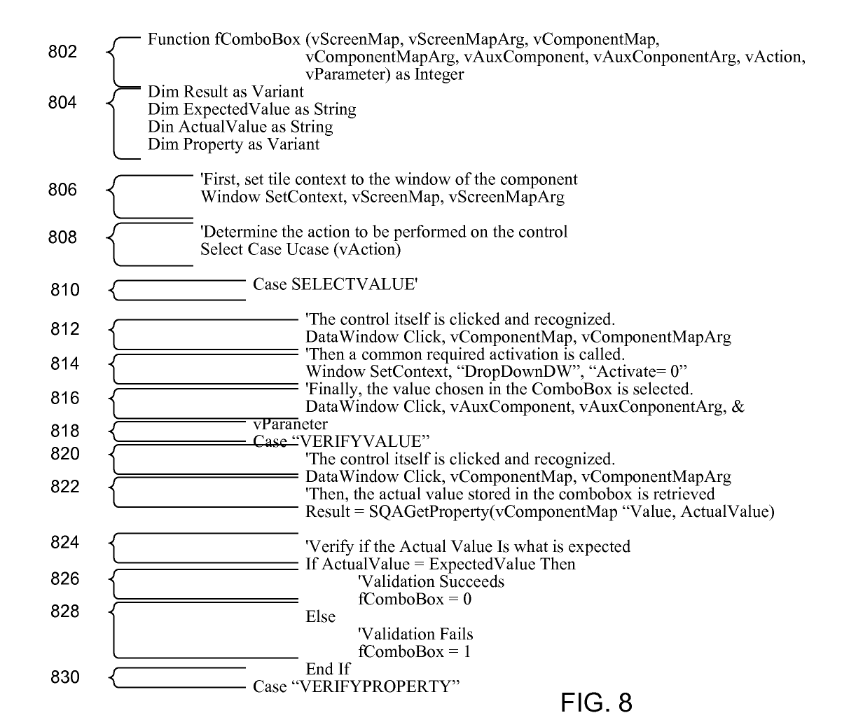

As described below in conjunction with FIGS. 7-8, the example test executor 104a described herein includes a main loop and a function library. The main loop reads the published test asset 112 and iterates over each line or segment of the published test asset 112. For each line or segment in the published test asset 112 that is designated for processing, the main loop determines what type of GUI element of the AUT 102 (e.g., a text box, a button, a combo-box, a text area, a radio button, a scroll bar, a checkbox, a calendar control, a status bar, a table, a list box, a window, an image, a label, a tab, a menu item, a toolbar, etc.) the line of the published test asset 112 is to act upon and calls the appropriate function in the function library for that GUI element of the AUT 102. The function library includes a set of functions for each type of GUI element of the AUT 102. For example, for a combo box GUI element the function library includes a function to select a value, to verify that an input value is selected, to verify a property of the combo box, etc. The main loop and the function library are described in further detail in conjunction with the description of FIGS. 7 and 8, respectively.

The GUI exporter 104b of the illustrated example retrieves information about the GUI of the AUT 102 and sends the information to the test creator 110. In one implementation, the example GUI exporter 104b retrieves from the operating system on which the AUT 102 is operating identification information about components of the GUI of the AUT 102. For example, the GUI exporter 104b and the AUT 102 may operate on a computer system running the Microsoft® Windows® operating system (not shown). In such an example, the example GUI exporter 104b would query the operating system for identification information (e.g., GUI element names assigned to the GUI elements by a programmer of the AUT 102) associated with the GUI of the AUT 102. Alternatively, the GUI exporter 104b may examine the AUT 102 itself (e.g., may review the source code of the AUT 102, may examine the compiled instructions of the AUT 102, etc.), may receive information about the GUI of the AUT 102 from a user (e.g., a user may manually input information about the AUT 102, etc.), or use any other method for receiving information about the GUI of the AUT 102. The GUI exporter 104b may use any available method to transfer the information about the GUI to the test creator 110 such as, for example, sending a file to the test creator 110, storing a file that the test creator 110 can access, sending a message directly to the test creator 110, storing data in a database accessible by the test creator 110, etc.

While the forgoing describes two components that are associated with the test engine 104, the test engine 104 may additionally include any other components. For example, the test engine 104 may include software applications/tools for editing test scripts, reviewing the results of tests, selecting applications to test, etc.

The test log 106 of the illustrated example is a database that stores the results of tests performed by the test executor 104a. Alternatively or additionally, the test log 106 may be a text or binary file storing the results or any type of storage capable of storing the results of tests. While the test log 106 of the illustrated example is a standalone storage component, the test log 106 may alternatively be integrated with the test engine 104, the test executor 104a, the external data store 108, or any other component of system 100.

The external data store 108 of the illustrated example is a database storing information used by the test executor 104a in performing tests. For example, the published test script 112 may reference information stored in the external data store 108 (e.g., a record, a field, a table, a query result, etc.). When the test executor 104a is operating on a line from the published test asset 112 and encounters the reference to external data, the test executor 104a retrieves the information from the external data store 108. For example, the published test script 112 may reference a record in the external data store 108 containing usernames and passwords to be tested against the AUT 102. When the test executor 104a encounters the referenced to the record in the external data store 108, the test executor 104a will retrieve the usernames and passwords and utilize them in testing the designated AUT 102. While the external data store 108 of the illustrated example is shown as a standalone storage component, the external data store 108 may alternatively be integrated with the test engine 104, the test executor 104a, the test log 106, or any other component of system 100.

The test creator 110 of the illustrated example is a software application or set of software applications that enables a user to generate test scripts that are output as the one or more published test assets 112. The example test creator 110 receives GUI information associated with the GUI of the AUT 102 from the GUI exporter 104b and allows a user to assign aliases to the elements of a received GUI. For example, when the GUI information includes non-descript names, aliases that explain the purpose or type of each GUI element may be assigned. Aliases aid in the creation of test assets by enabling users to easily identify GUI elements. The test creator 110 provides a user with tools to create tests for the received GUI.

The tests of the example test creator 110 include four categories: test instructions, test steps, test cases, and test suites. A test instruction is a single instruction to the test executor (e.g., the test executor 104a). For example, a test instruction may instruct the test executor to select a particular GUI screen of the AUT 102, to select a particular GUI element of the selected GUI screen, and/or to perform a particular action on the selected GUI element (e.g., select a button, select a value in a combo box, input text in a text field, verify a value in a text area, etc.), etc. A test step is a group of test instructions. For example, a test step may be a group of instructions that test a single GUI element. A test case is a group of test steps. For example, a test case may be a group of test steps that tests a single GUI screen. A test suite is a group of test cases. For example, a test suite may be a group of test cases that test a single AUT (e.g., the AUT 102).

The use of test steps, test cases, and test suites depends on the particular application of the system 100. For example, the AUT 102 may include a GUI having four distinct parts, each part having several GUI elements. A user of the system 100 may create a test step for each GUI element. The user may create a test case for each of the four distinct parts of the GUI, each test case including the test steps associated with the GUI elements of the respective part of the GUI. The user may then create a test suite that includes the four test cases. The use of test instructions, steps, cases, and suites allows for abstraction of created tests. Accordingly, test reuse is possible because individual parts of tests can be included in other tests. In other words, test assets stored in the test creator data store 208 may be retained after a test has been completed and may be reused and/or modified at a later time. For example, a test step or test case from one test suite can be added to a second test suite without having to rewrite the test step or test case.

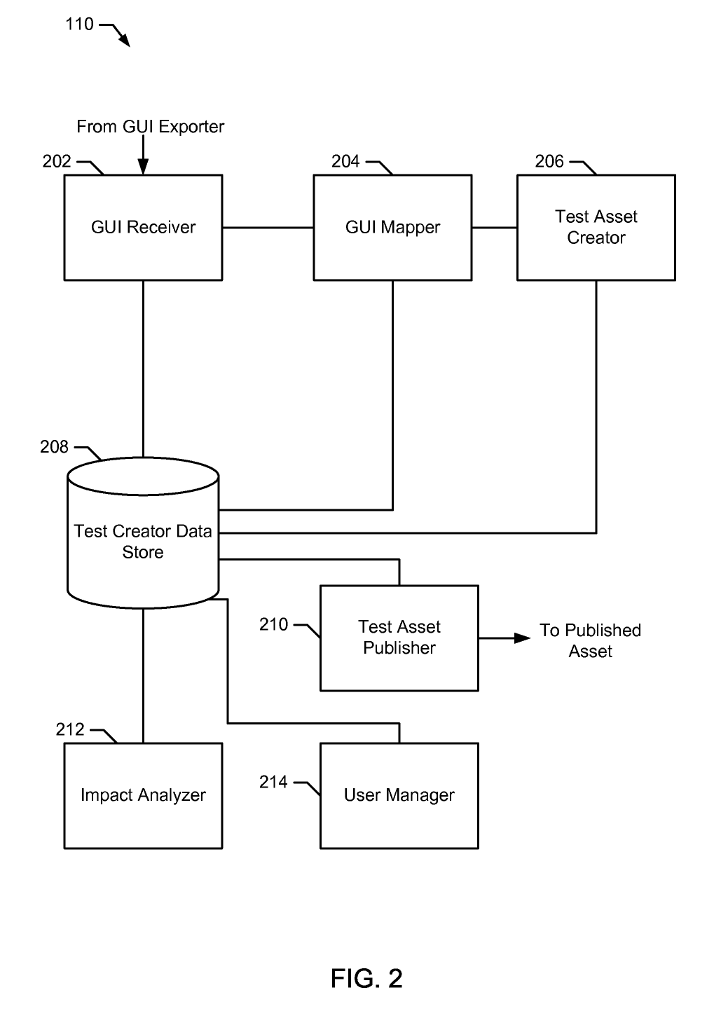

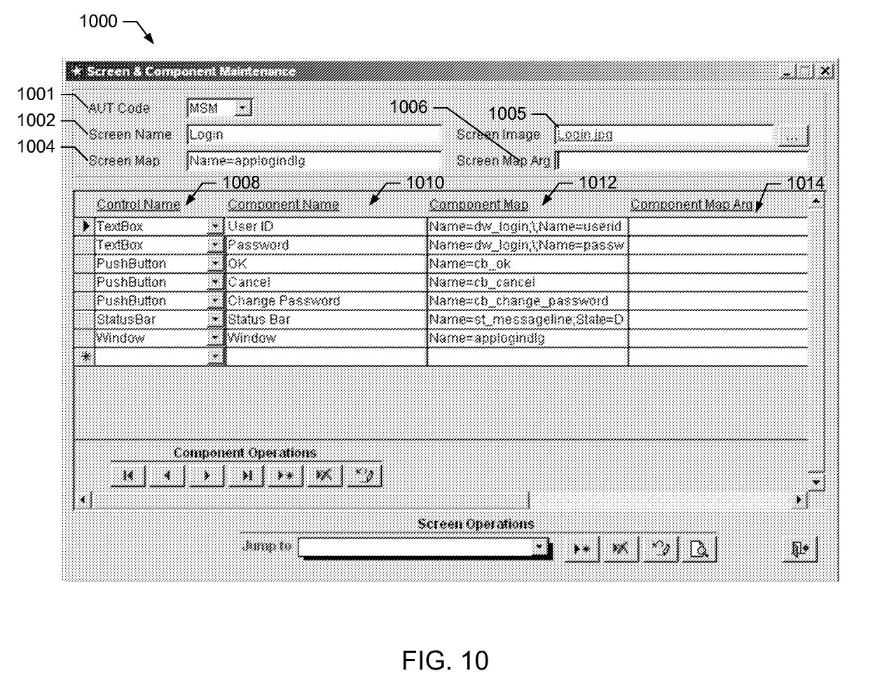

The test creator 110 of the illustrated examples provides graphical user interface wizards to enable a user to assign aliases to the GUI elements of the AUT 102; to create test instructions, test steps, test cases, and test suites; and to output the one or more published test assets 112. Example graphical user interface wizards are illustrated in FIGS. 10-15. An example implementation of the test creator 110 is described in conjunction with FIG. 2. However, any method for enabling a user to interface with the test creator 110 may be used such as, for example, a command line interface, a menu-drive interface, a table layout interface, etc.

The one or more published test assets 112 of the illustrated example are output by the test creator 110 and received by the test executor 104a. The example one or more published test assets 112 are one or more files containing comma separated text describing tests created by a user of the test creator 110 to be performed on the AUT 102. The published tests assets 112 may alternatively be any other type of file format (e.g., extended markup language (XML), any type of binary format, a tab separated format, any type of delimited format, etc.), may be information stored in a database (e.g., the external data store 108 or any other database), may be information sent directly from the test creator 110 to the test executor 104a, etc.

FIG. 2 is a block diagram of an example implementation of the test creator 110 of FIG. 1. The example test creator 110 comprises a GUI receiver 202, GUI mapper 204, a test asset creator 206, a test creator data store 208, a test asset publisher 210, an impact analyzer 212, and a user manager 214.

The GUI receiver 202 of the illustrated example receives GUI information associated with the AUT 102 from the GUI exporter 104b. The example GUI receiver 202 provides a user interface to a user to enable the user to specify a file that contains the GUI information associated with the AUT 102 exported by the GUI exporter 104b. The GUI receiver 202 may additionally enable the user to specify a file that contains a screenshot or image of the GUI. Alternatively, the GUI receiver 202 may receive a data stream from the GUI exporter 104b containing information about the GUI, may connect to a database containing the GUI information, etc. In addition, the GUI receiver 202 may alternatively receive a data stream from the GUI exporter 104b containing a screenshot or image of the GUI, may generate an image or screenshot of the GUI (e.g., may access an interface from the operating system on which the AUT 102 is running to generate a screenshot, may reproduce an image of the GUI based on information received from the GUI exporter 104b, etc).

The information about the GUI describes the GUI of the AUT 102. For example, the information about the GUI may include a list of GUI elements, the type of each element in the GUI, the location of each element in the GUI, an internal system name for each element of the GUI, an input size (e.g., a text field must have an input size of 15 characters) for each element of the GUI, etc. Alternatively, the information about the GUI may include any other information available about the GUI of the AUT 102. While a single GUI has been described, it should be understood that any number of GUIs may be included and information about one or more GUIs may be received by/provided to the GUI receiver 202.

After receiving information about the GUI of the AUT 102, the GUI receiver 202 stores the information in the test creator data store 208. Alternatively, the GUI receiver 202 may transmit the information to the GUI mapper 204. The GUI receiver 202 may make changes to the information about it is received. For example, the GUI receiver 202 may convert the information to a different format, may filter the information to receive unnecessary information, etc.

The GUI mapper 204 of the illustrated example provides a user interface to enable a user of the example test creator 110 to provide further information about the GUI of the AUT 102. For example, the example GUI mapper 204 enables a user to assign aliases to elements of the GUI, to specify the type (e.g., text area, text field, combo box, radio button, etc.) of each element of the GUI, to specify actions (e.g., select a value, input a value, click a button, etc.) that can be performed on each element of the GUI, and to specify a source of sample data associated with each element of the GUI. Information about the GUI provided by a user of the GUI mapper 204 is stored in the test creator data store 208. Alternatively, the information may be transmitted to the test asset creator 206.

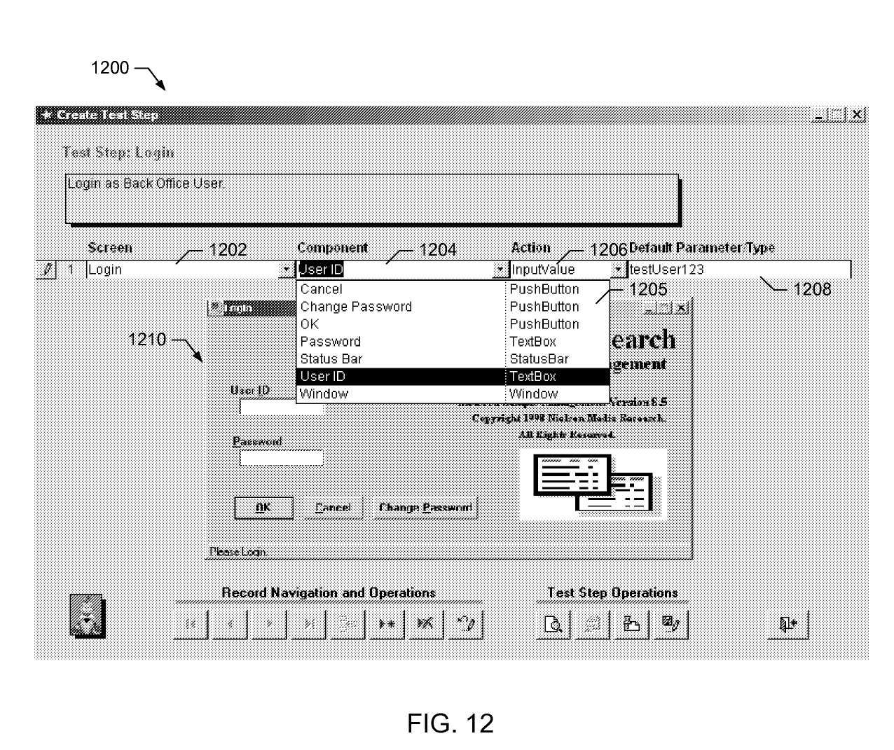

The test asset creator 206 of the illustrated example receives information about the GUI of the AUT 102 from the GUI mapper 204 and/or the test creator data store 208. The example test asset creator 206 provides a user interface to enable a user of the example test creator 110 to specify tests that are to be performed on the AUT 102. The example test creator 110 provides a user interface for test step creation, a user interface for test case creation, and a user interface for test suite creation. Example user interfaces that may be provided by the test asset creator 206 are illustrated in FIGS. 12-15.

While the following paragraphs describe example user interfaces that are provided by the test asset creator 206, any user interface may be used to implement the test asset creator 206.

The example user interface for test step creation of the test asset creator 206 provides a user with a list of GUIs of the AUT 102 that may be selected. After the user selects a GUI, the user interface provides the user with a list of GUI elements associated with the selected GUI. In addition, the example user interface displays a screen shot or image of the GUI. After the user selects a GUI element, the user interface provides the user with a list of possible actions that can be performed on the selected element. After the user selects one of the possible actions, the user provides an input field for the user to input any data that may used for the selected action. For example, if a user selects to input a value in a text field, the user inputs the value in the provided input field. The user may directly enter values in the provided input field or, alternatively, the user may input information that causes the data to be imported when the test step is performed. For example, the user may input a database query instruction that causes information to be retrieved from an external database (e.g., external data store 108).

The example user interface for test case creation of the test asset creator 206 provides a user with a list of test steps that have been created. The user can select one or more test steps to be added to the test case. In addition, the user interface allows a user to select a desired order for performance of the test steps. The user interface also enables a user to view and edit the test instructions that have been added to a test case (i.e., the instructions that are a part of the test steps that have been added to a test case). In addition to enabling the user to edit the values that are used as part of the selected action of a test instruction, the user interface also enables a user to indicate whether the test case should be interrupted when a test instruction fails, to be interrupted when a test instruction passes, and whether an individual instruction should be processed. If the test case is interrupted, the test engine (e.g., test engine 104) executing the test case will stop executing test instructions and report a message (e.g., a message indicating that the test passed or failed) to the user.

The example user interface for test suite creation of the test asset creator 206 provides a user with a list of test cases that have been created. The user can select one or more test cases to be added to the test suite. In addition, the user interface allows a user to select a desired order for performance of the test cases. The user interface additionally enables a user to indicate that certain test cases that are added to the test suite are not to be performed. For example, a user may want to add the test cases to the test suite for later user and, thus, may designate that the test cases that are to be used later are not to be processed at this time.

After a user has used the user interfaces of the example test asset creator 206 to generate test steps, test cases, and test suites, the test asset creator 206 stores information about the test steps, test cases, and test suites in the test creator data store 208. Alternatively, the test asset creator 206 may transmit information about the test steps, test cases, and test suites directly to the test asset publisher 210.

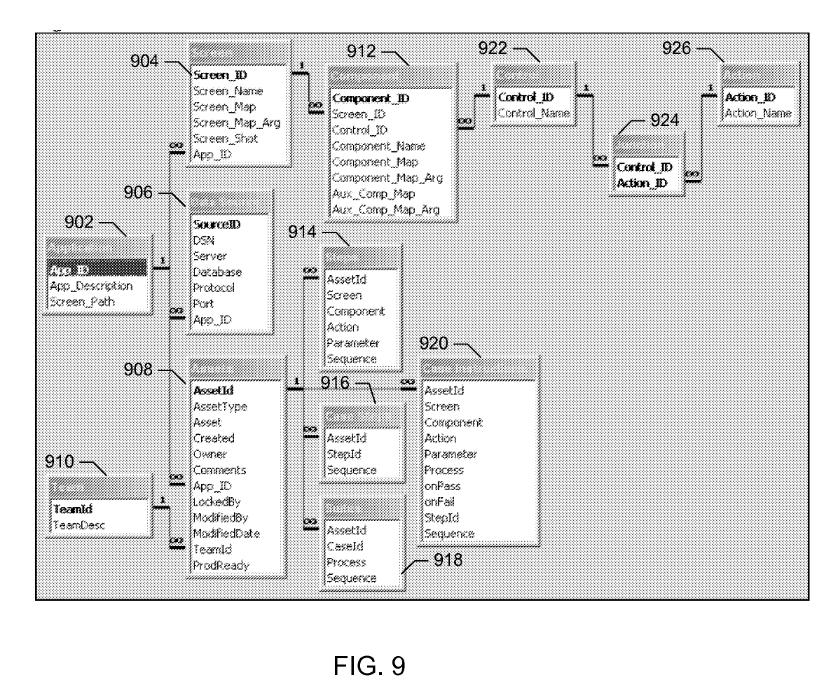

The test creator data store 208 of the illustrated example is a Microsoft® Access™ database storing information about GUIs of the AUT 102; test steps, test cases, and test suites from the test creator 106, and user access information from the user manager 214. Alternatively, any other type of data storage component may be used. For example, the test creator data store 208 may alternatively be implemented by any other type of database (e.g., a Microsoft® SQL Server database, a MYSQL® database, an Oracle database®, any other relational database, etc.), a file stored in a memory (e.g., a text file, a Microsoft® Excel® file, a comma separated text file, a tab separated text file, etc.), or any other type of data storage. An example data map for implementing the test creator data store 208 is illustrated in FIG. 9.

The test asset publisher 210 of the illustrated example retrieves test asset information (e.g., information about test steps, test cases, and test suites) from the test creator data store 208. The test asset publisher 210 may provide a user of the example test creator 110 with a user interface that enables the user to request publishing of a test asset. For example, a user interface may allow the user to specify a file, database, test engine (e.g., test engine 104) or any other location to receive the published test asset. In addition, the test asset publisher 210 may enable the user to specify a format (e.g., XML, comma separated text file, etc.) for the published test asset. The example test asset publisher 210 is also capable of instructing a test engine to begin executing a published test asset. For example, the test asset publisher 210 may publish a test asset (e.g., published test asset 112) and then send a message to a test engine (e.g., test engine 104) instructing the test engine to begin performing the tests described in the published test asset. The test asset publisher 210 may automatically publish test assets as they are completed. In addition, the test asset publisher 210 may delete or update published test assets as they are modified by the test creator 110. Alternatively, any other method of outputting a test asset and/or instructing a test engine to execute the test asset may be used.

The example impact analyzer 212 of the test creator 110 identifies test assets that will be impacted by changes to the GUI of the AUT 102. For example, the impact analyzer 212 may provide a user to select a GUI for which information has been stored in the test creator data store 208 and indicate that an element of the GUI will be changed (e.g., the name of the element will be changed, the element will be removed from the GUI, the element type will be changed, etc.). The example impact analyzer 212 reviews the test assets that are stored in the test creator data store 208 to determine if the change to the GUI element will affect any of the test assets. The impact analyzer of the illustrated example then reports the test assets that will be affected to the user. Alternatively, the impact analyzer 212 may analyze information about a changed GUI received by the GUI receiver 202 and determine if changes to the GUI will affect test assets. For example, the impact analyzer 212 may be automatically activated when information about a GUI is received by the GUI receiver 202 or may be manually triggered by a user of the test creator 110.

In addition to identifying test assets that will be impacted by changes to a GUI, the impact analyzer 212 also enables changes to the GUI to be processed. For example, if the type of a GUI element is changed (e.g., a combo box is changed to a text box), the impact analyzer 212 can automatically (or after user input) modify all test assets that reference the GUI element to reference the new type of the GUI element. In other words, the impact analyzer 212 allows changes to a GUI to be automatically distributed to available test assets.

The user manager 214 of the illustrated example enables a user to configure user access information for the test creator 110. For example, the user manager 214 may authenticate users before they are allowed to access the test creator 110. The user manager 214 may access a user access list stored in the test creator data store 208. For example, the user access list may include a username, a password, a group membership, and a user profile for each user. The user manager 214 may restrict access to the test creator 110 and/or to access/modification of test assets based on the user access list. For example, test assets may be designated as in-progress or production-ready. Test assets that are in-progress may be restricted to access/modification by a subset of all of the users. The user manager 214 may also store information about the preferences of a user. For example, the user manager 214 may store information about a user's preferred AUT (e.g., an AUT that the user selected as their preference, an AUT that was last used by the user, etc.), the user's preferences regarding automatic publication and/or execution of test assets, a user's preferred external data store, etc.

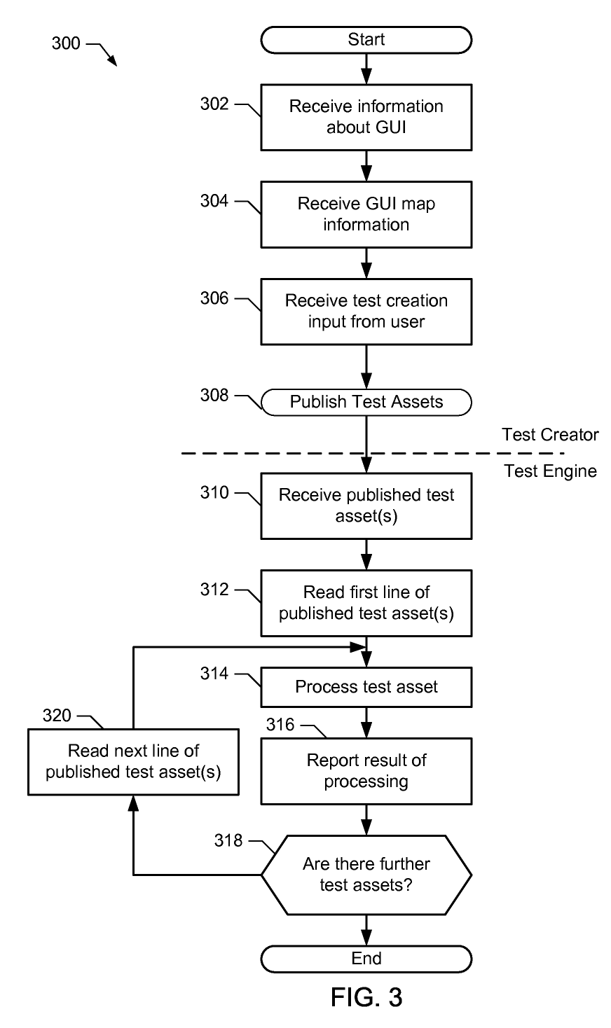

Having described the architecture of an example system that may be used to analyze computer software, various processes are described in FIGS. 3, 4, and 5. Although the following discloses example processes, it should be noted that these processes may be implemented in any suitable manner. For example, the processes may be implemented using, among other components, software, machine readable code/instructions, or firmware executed on hardware. However, this is merely one example and it is contemplated that any form of logic may be used to implement the systems or subsystems disclosed herein. Logic may include, for example, implementations that are made exclusively in dedicated hardware (e.g., circuits, transistors, logic gates, hard-coded processors, programmable array logic (PAL), application-specific integrated circuits (ASICs), etc.), exclusively in software, exclusively in machine readable code/instructions, exclusively in firmware, or some combination of hardware, firmware, and/or software. Additionally, some portions of the process may be carried out manually.

While the following processes are described in conjunction with the hardware of FIGS. 1 and 2, the blocks/processes need not be associated with the hardware of FIGS. 1 and 2 in the manner described. That is, different hardware blocks may perform different steps than those described. In addition, any hardware capable of performing the described processes may be used.

Furthermore, while each of the processes described herein is shown in a particular order, those having ordinary skill in the art will readily recognize that such an ordering is merely one example and numerous other orders exist. Accordingly, while the following describes example processes, persons of ordinary skill in the art will readily appreciate that the examples are not the only way to implement such processes.

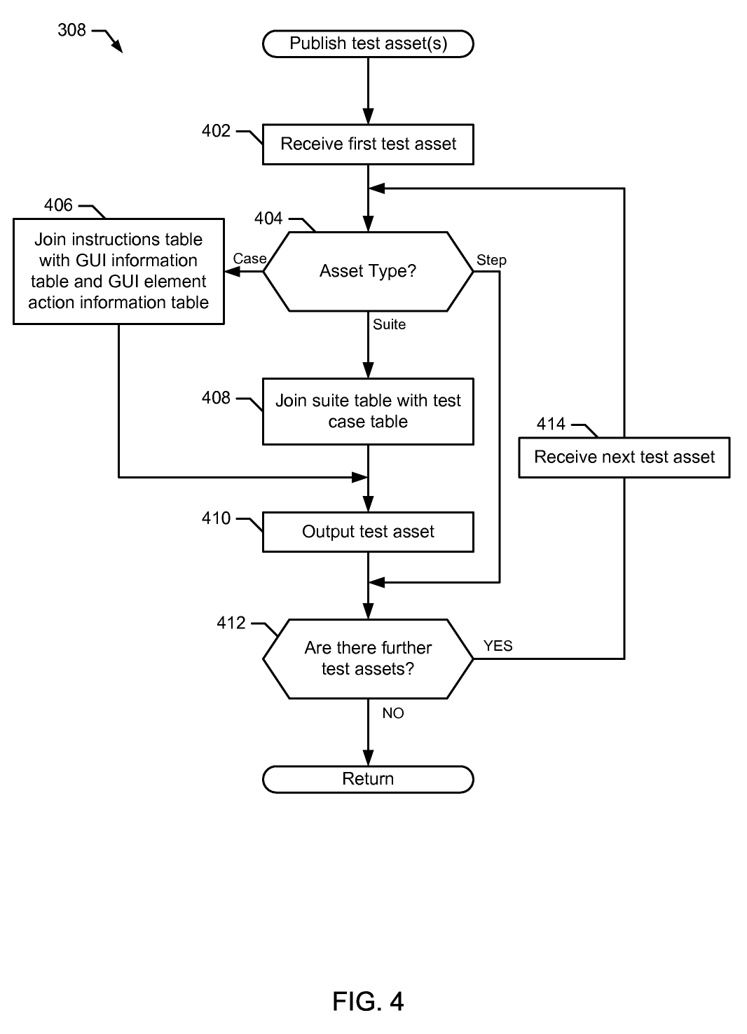

FIG. 3 is a flowchart illustrative of an example process 300 to create and process software tests. The example process 300 begins when the test creator 110 of FIG. 1 receives information about the AUT 102 (block 302). As previously described, in an example implementation, the GUI exporter 104b of the test engine 104 retrieves GUI information from the AUT 102 and transmits the GUI information to the test creator 110. Then, a user of the system 100 inputs GUI mapping information that is received by the GUI mapper 204 of FIG. 2 (block 304). Then, the user of the system 100 inputs test creation information (e.g., describes test instructions, test steps, test cases, and test suites) using the test asset creator 206 (block 306). For example, the user may use the previous described user interfaces that are illustrated in FIGS. 12-15. After the user finishes inputting test creation information, the test asset publisher 210 publishes the one or more test assets 112 (block 308). An example implementation of a process for publishing test assets is described in further detail in conjunction with the description of FIG. 4.

The process 300 may end after block 308 if a user does not plan to perform the test immediately. For example, a user may publish test assets that will be used at a later time. When the user intends to perform the test, the test executor 104a of the test engine 104 receives the one or more published test assets 112 (block 310). The test executor 104a reads the first line of the published test assets 112 (block 312). If the first line of the published test assets 112 is a test suite, then the test executor 104a reads the first line of the first test case of the test suite. Then, the test executor 104a performs the test referenced on the first line of the published test assets 112 (block 314). For example, the test may indicate that the test executor 104a should input a value in a text field of the AUT 102, should click a button on the AUT 102, etc. The test executor 104a then determines if the test was successful and reports the result (block 316). For example, if the test was successful, the test executor 104a will output a pass result to the test log 106 and if the test is not successful, the test executor 104a will output a fail result to the test log 106.

After outputting the result of the test, the test executor 104a determines if there are further test assets in the published tests assets 112 (block 318). If there are further test assets to process, the test executor 104a reads the next line of the published test assets 112 (block 320) and control proceeds to block 314 to process the next test asset. If there are no further test assets to process, the test executor 104a completes. For example, the test executor 104a may display a message to a user indicating that all tests are complete.

FIG. 4 illustrates the process to publish test assets 308 of FIG. 3. The example process 308 begins when the test asset publisher 210 of FIG. 2 receives a first test asset (block 402). Alternatively, the test asset publisher 210 may receive an instruction to publish test assets and may retrieve the first test asset from the test creator data store 208. The test asset publisher 210 then determines the type of the received test asset (block 404). If the test asset is a test step, nothing is published for the test asset and control proceeds to block 412.

If it is determined that the test asset is a test case (block 404), the test asset publisher 210 joins the table containing the test instructions of the test case, the table containing the GUI elements for the GUI on which the test is to be performed, and the table containing actions associated with GUI elements (block 406). For example, if the test creator data store 208 is a database, the data in the table containing the test instructions, the table containing the GUI elements, and the table containing actions are linked to form a single table. Control then proceeds to block 410.

If it is determined that the test asset is a test suite, the test asset publisher joins the table containing the test suite with the table containing the test cases (block 408). Control then proceeds to block 410.

After joining tables (blocks 406 and 408), the test asset publisher 210 outputs (publishes) the test asset as the published test asset 112 (block 410). The test asset publisher 210 may append the published test asset 112, may create a new published test asset 112, or may overwrite the published test asset 112. Alternatively, the test asset publisher 210 may transmit the test asset directly to the test executor 104a.

After outputting the test asset (block 410), the test asset publisher 210 determines if there are further test assets to process (block 412). If there are no further test assets to process, control returns to the example process 300. If there are further test assets to process (block 412), the test asset publisher receives the next test asset (block 414) and control proceeds to block 404 of FIG. 4.

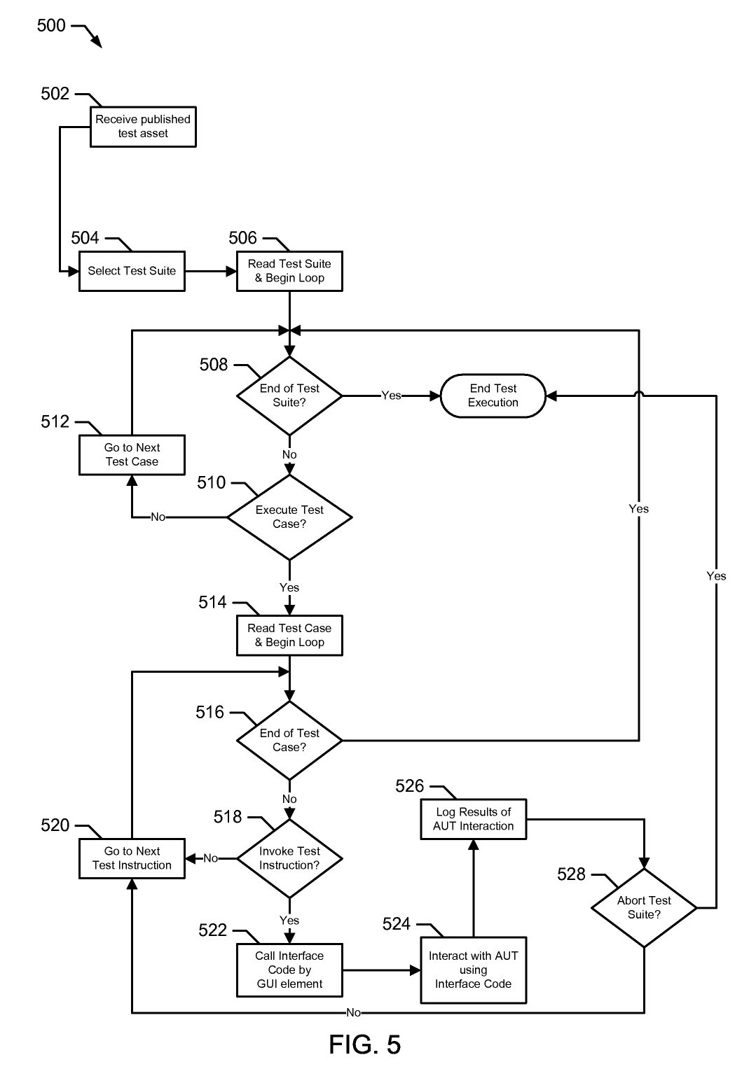

FIG. 5 illustrates an example process 500 for implementing the test executor 104a of FIG. 1. The example process 500 begins when the published test asset 112 is received by the test executor 104a (block 502). The test executor 104a then selects the first test suite from the published test asset 112 (block 504). The test executor 104a then reads the test suite and begins processing the test assets (block 506).

The test executor 104a then determines if the end of the test suite has been reached (block 508). If the end of the test suite has been reached, the test execution completes. If the end of the test suite has not been reached (block 508), the test executor 104a determines if the first test case in the test suite has been designated for processing (e.g., the user indicated that the test case should be processed) (block 510). If the test executor 104a determines that the first test case has not been designated for processing, the test executor 104a attempts to move to the next test case (block 512) and control returns to block 508 to process the next test case. If the test executor 104a determines that the first test case has been designated for processing, the test executor 104a reads the test case and begins processing the test instructions (block 514).

The test executor 104a then determines if the end of the test case has been reached (block 516). If the end of the test case has been reached, control returns to block 508 to continue processing the test suite. If the end of the test case has not been reached, the test executor 104a then determines if the next test instruction in the test case has been designated for processing (e.g., whether the user indicated that the test instruction and/or test case should be processed or ignored) (block 518). If the test instruction has not been designated for processing, the test executor 104a moves to the next test instruction (block 514) and control proceeds to block 516. If the test instruction has been designated for processing, the test executor 104a calls the function of the interface of the test engine 104 that is associated with the GUI element associated with the test instruction (block 522). For example, if the test instruction indicates that an action is to be performed on a text box, the test executor 104a calls the function of the interface that is associated with text boxes.

Then, the test engine 104 interacts with the GUI of the AUT 102 to perform the action specified by the test instruction (block 524). The test executor 104a then determines if the test was successful and logs the results to the test log 106 (block 526). For example, if the test case indicated that a value should be entered in a text box, the test executor 104a will record a pass in the test log 106 if the text was successfully entered in the text box and a fail if the text was not successfully entered in the text box. Then, based on the result of the test case, the test executor 104a determines if it should abort the test case (block 528). For example, a test case may indicate that if a test instruction passes the test case should be aborted and another test case may indicate that if a test instruction fails the test case should be aborted. If the test case is to be aborted, the execution of the test suite is complete. If the test case is not to be aborted, control proceeds to block 520 to process the next instruction of the test case.

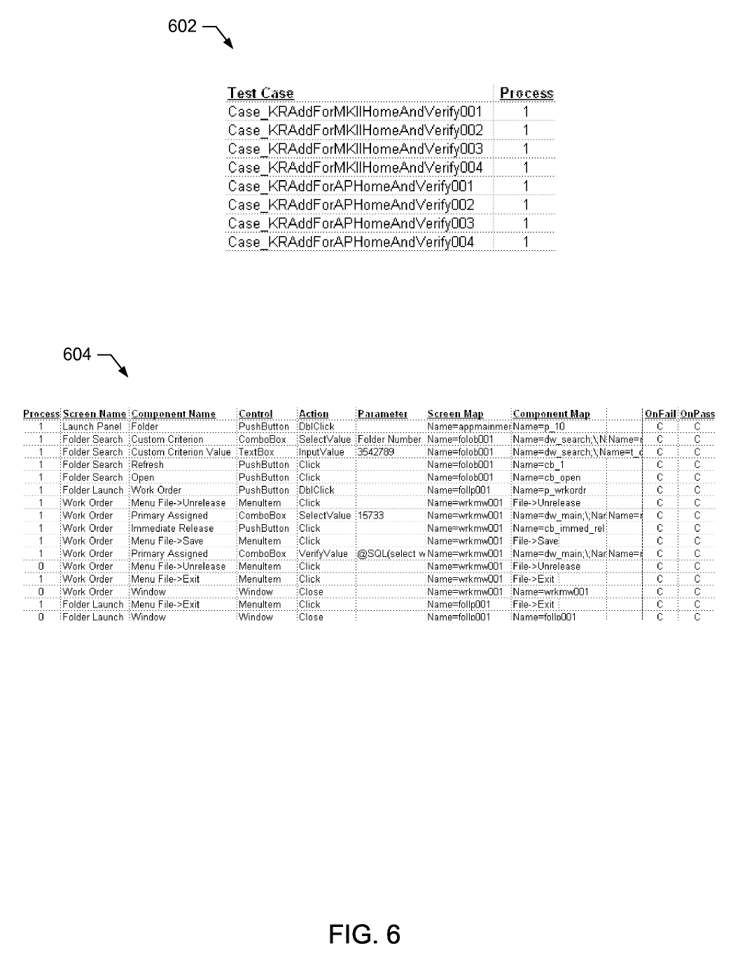

FIG. 6 illustrates examples of the one or more published test assets 112 of FIG. 1. A test suite file 602 illustrates an example test suite as a published test asset. A test case file 604 illustrates an example test case as a published test asset. The example published test assets of FIG. 6 are spreadsheet representations of comma separated text files. In a comma separated text file a true/false checkbox may be represented by a ‘1’ indicating a true value and a ‘0’ indicating a false value or any other representation may be used. Alternatively, the published test assets may be stored and/or represented in any other format or representation such as, for example, an XML file, a Microsoft® Excel® file, etc.

The test suite file 602 includes a column to store the name of the test cases in the test suite and a column to store a true or false value indicating whether each of the test cases of the test suite should be processed. The names of the test cases stored in the test suite file 602 allow the test executor 104a to retrieve the test cases. In other words, the test case name is linked to a data source that stores the test cases (e.g., a published test asset stored in a database). In addition, the test suite file 602 may store any additional information associated with the test suite.

The test case file 604 stores a list of test instructions that are associated with the test case in the test case file 604. The test case file 604 includes a column to store a 1 or a 0 (i.e., true or false) value indicating whether each of the test instructions of the test case should be processed, a column to store a GUI screen associated with a test instruction, a column to store a GUI name of a component/element associated with a test instruction (e.g., a alias name, an internal name for the GUI component/element, etc.), a column to store a control/element type for a GUI component/element associated with a test instruction, a column to store an action associated with a test instruction, a column to store a parameter/value/default value associated with a test instruction, a column to store the internal screen map name of the screen, a column to store the internal component map name of a component, a column to store whether the test case should continue or abort after a test instruction fails, and a column to store whether the test case should continue or abort after a test case passes. In addition, the test case file 604 may store any additional information associated with the test case.

FIGS. 7-8 illustrate example machine readable instructions that may be used to implement the test executor 104a of FIG. 1.

In general, the machine readable instructions of FIG. 7 read a published test asset (e.g., the published test asset 112 of FIG. 1) and iterate over the lines of the published test asset to call an appropriate function (e.g., a function in the machine readable instructions of FIG. 8) for each line of the published test asset.

At line 702, the published test asset (e.g., published test asset 112 of FIG. 1) is read. For example, a test suite selected by a user is opened. At line 704, the machine readable instructions enter a loop that ends when the end of the file referenced in line 702 is reached. Lines 706 read the next line (e.g., the first line during the first iteration) and determine if the process bit is set to true. For example, each line of the test suite includes the name of a test case and a bit that indicates whether each test case should be processed. If the process bit is not set, the next case is processed. If the process bit is set, at lines 708, messages are displayed and logged indicating that the test is starting.

At line 710, the file corresponding to the test case named in the read test suite is opened for input and a loop is entered to iterate over the test case. At line 712, the fields of the next line (e.g., the next test instruction) of the test case are read. At line 714, the example machine readable instructions determine if the process bit for the read line is set to true. If the process bit is not set to true, the next line is processed. If the process bit is set to true, at line 716, a case structure is entered based on the GUI element type of the read line of the test case.

At line 718, the case block is entered if the GUI element type of the read line of the test case is “Combo Box.” At lines 720, the function associated with the “COMBOBOX” GUI element type is called. The called function performs the action specified by the read line of the test case. For example, a function in the function library illustrated in FIG. 8 may be called. If the function returns a result indicating that the action was performed successfully, then, at lines 722 a “pass” result is logged (e.g., is logged to the test log 106 of FIG. 1. If the function returns a result indicating that the action was not performed successfully, then, at lines 724 a “fail” result is logged.

At line 726, the case block for “COMBOBOX” ends and the case block is entered if the GUI element type of the next read line of the test case is “List Box.” At lines 728, the function associated with the “List Box” GUI element type is called. The called function performs the action specified by the read line of the test case. If the function returns a result indicating that the action was performed successfully, then the instructions after line 730 are executed.

While only a subset of the machine readable instructions are illustrated in FIG. 7 for purposes of explanation, persons of ordinary skill in the art will recognize that the machine readable instructions of FIG. 7 may additionally include further instructions to process other types of GUI element types.

FIG. 8 illustrates machine readable instructions that implement functions for performing actions associated with GUI elements. In particular, a function for processing “COMBOBOX” type GUI elements is illustrated. In an example implementation, the machine readable instructions of FIG. 8 are called by the machine readable instructions of FIG. 7 as published test assets (e.g., published test asset 112 of FIG. 1) are processed.

At lines 802, the function for processing “COMBOBOX” type GUI elements is defined. At lines 804, variables that are used by the function are initialized. At lines 806, the system context is set to the screen of the GUI that is to be tested. In other words, the window of the GUI is activated for control. At lines 808, a case structure is initiated based on the action specified by the received test instruction.

At line 810, the case block is entered if the action of the test instruction is “SELECTVALUE.” At lines 812, the GUI element associated with the test instruction is selected. At lines 814, the combo box drop down element is activated. At lines 816, the value specified by the “SELECTVALUE” is selected.

At line 818, the case block for “SELECTVALUE” ends and the next case block is entered if the action of the next test instruction is “VERIFYVALUE.” At lines 820, the GUI element associated with the test instruction is selected. At lines 822, the value selected in the GUI element is read. At lines 824, it is determined whether the read value matches the value specified in the test instruction. If the value read matches the specified value, the function reports a success value at lines 826. If the value read does not match the specified value, the function reports a failure at lines 828.

At line 830, the case block for “VERIFYVALUE” ends and the next case block is entered if the action of the next test instruction is “VERIFYPROPERTY.”

While only a subset of the machine readable instructions are illustrated in FIG. 8 for purposes of explanation, persons of ordinary skill in the art will recognize that the machine readable instructions of FIG. 8 may additionally include further instructions to operate on other types of GUI element types.

FIG. 9 illustrates an example data model/layout for the test creator data store 208. The example data model comprises an application table 902, a screen table 904, a data source table 906, an assets table 908, a team table 910, a component table 912, a steps table 914, a case steps table 916, a suites table 918, a case instructions table 920, a control table 922, a junction table 924, and an action table 926.

The application table 902 stores information about applications that are available for testing. The application table 902 is linked to the screen table 904, the data source table 906, and the assets table 908 based on an asset ID (e.g., a unique identifier assigned to each application).

The screen table 904 stores information about the screens of the applications identified in the application table 902. The screen table 904 is linked to the component table 912 based on a screen identifier.

The component table 912 stores information about the components/GUI elements of the associated screen in the screen table 904. The component table 912 is linked to the control table 922 based on a control identifier. The control table 922 stores the control type for the associated component in the component table 912. The control table is linked to the junction table 924 based on the control identifier. The junction table 924 links the control table 922 with the action table 926. The junction table 924 is linked to the action table 926 based on an action identifier. The action table 926 stores information about the actions that are available for the associated control in the control table 922.

The data source table 906 stores information about data sources that are available for use in testing. For example, the data source table 906 may store information about the external data store 108 of FIG. 1.

The assets table 908 stores information about available test assets (e.g., test instructions, test steps, test cases, and test suites) that operate on the applications identified in the application table 902. The assets table 908 is linked to the team table 910, the steps table 914, the case steps table 916, and the case instructions table 920 based on an asset identifier.

The steps table 914 stores information about the test steps that have been created. For example, as a user creates test steps, the test instructions associated with the test steps (e.g., test instructions from the test instructions table 920) are added to the steps table 914.

The case steps table 916 stores information about the test steps (e.g., test steps from the steps table 914) that are associated with a test case and the order in which those test steps are to be performed.

The suites table 918 stores information about test cases that are associated with a test suite and the order in which those test cases are to be performed.

The case instructions table 920 stores information about test instructions that have been created in or added to the associated test steps in the case steps table 916.

The data model illustrated in FIG. 9 is provided as an example and any data layout may be used to implement the system 100 of FIG. 1.

FIG. 10 illustrates an example component mapping GUI 1000 for use with the test creator 110 of FIG. 1. The example component mapping GUI 1000 allows a user to input information about a GUI screen. In the illustrated example, a user selects an AUT using element 1001, a user enters the name for the screen using element 1002, the GUI map for the screen using element 1004, a location of a screen shot of the screen using element 1005, an argument for the screen using element 1006 (e.g., an argument used by the test engine such as, for example, the dimensions of the screen), the type of control for each element of the GUI using element 1008, the alias name for each element of the GUI using element 1010, the control name/internal name for each element of the GUI using element 1012, and an argument for each element of the GUI using element 1014 (e.g., an argument used by the test engine such as, for example, the coordinates of the component).

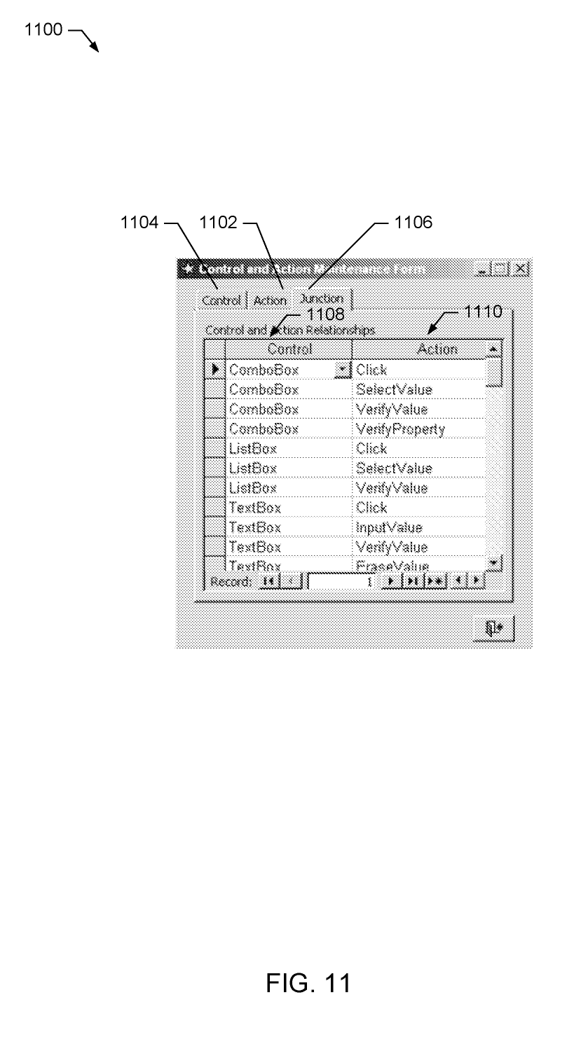

FIG. 11 illustrates an example maintenance GUI 1100 that allows a user to modify control types (e.g., text box, combo box, etc.) using a control tab 1104, action types (e.g., select value, verify value, etc.) using an action tab 1102, and to edit the link between action and control using a junction tab 1106. In other words, the maintenance GUI 1100 allows a user to specify which actions are associated with each control type using a control column 1108 and an action column 1110.

FIG. 12 illustrates an example test step creation GUI 1200 that allows a user to create and edit test steps. A user of the test step creation GUI 1200 selects a GUI screen using element 1202, selects a component of the selected GUI screen using element 1204 (which causes the control type of the component to be shown in box 1205), selects an action of the selected component using element 1206, and inputs a default value or data source link using element 1208. When a user selects a particular screen, a screenshot of the screen is displayed.

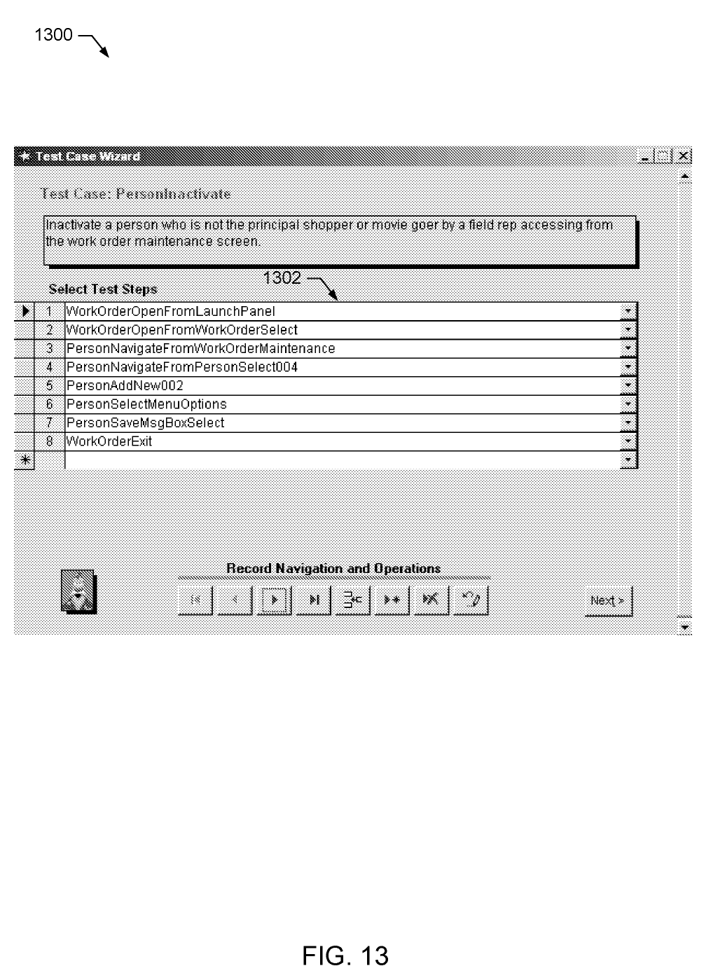

FIG. 13 illustrates an example first part of a test case creation GUI 1300. The example test case creation GUI 1300 allows a user to select test steps to be added to a test case using drop down menus 1302 that provide lists of test steps that are available.

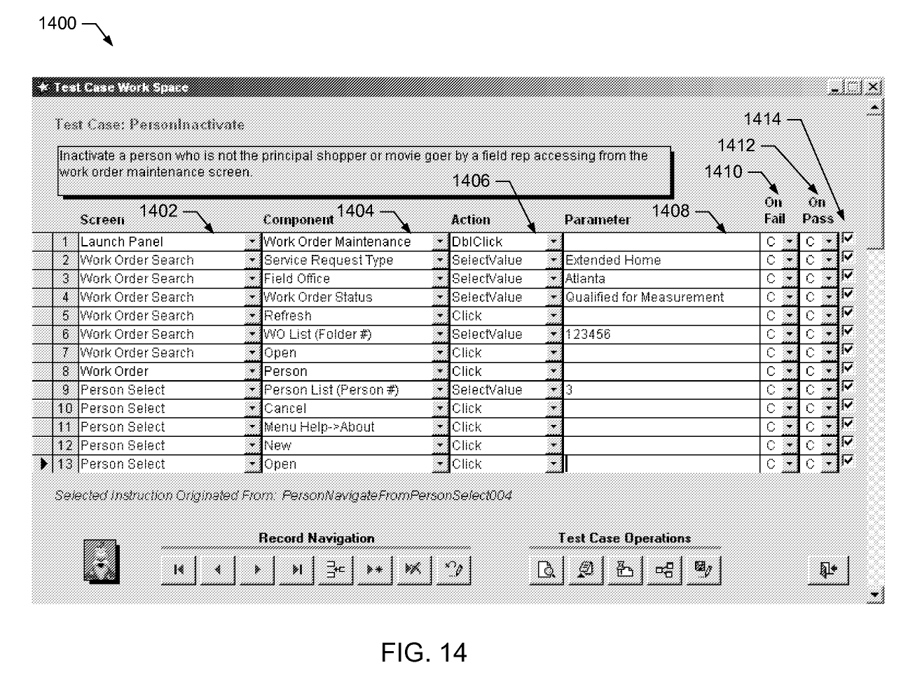

FIG. 14 illustrates an example second part of a test case creation GUI 1400. After a user has input the desired test steps to be a part of a test case using the first part of the test case creation GUI 1300, the second part of the test case creation GUI 1400 allows a user to view and edit the test instructions that are associated with the selected test steps. The user can edit the screen to be tested using drop down menus 1402, the component to be tested using drop down menus 1404, the action to be performed using drop down menus 1406, the default or requested parameter using drop down menus 1408, can change whether the test case will abort if the test case passes/fails using text boxes 1410 and 1412, and can indicate whether each individual test instruction should be processed using checkboxes 1414.

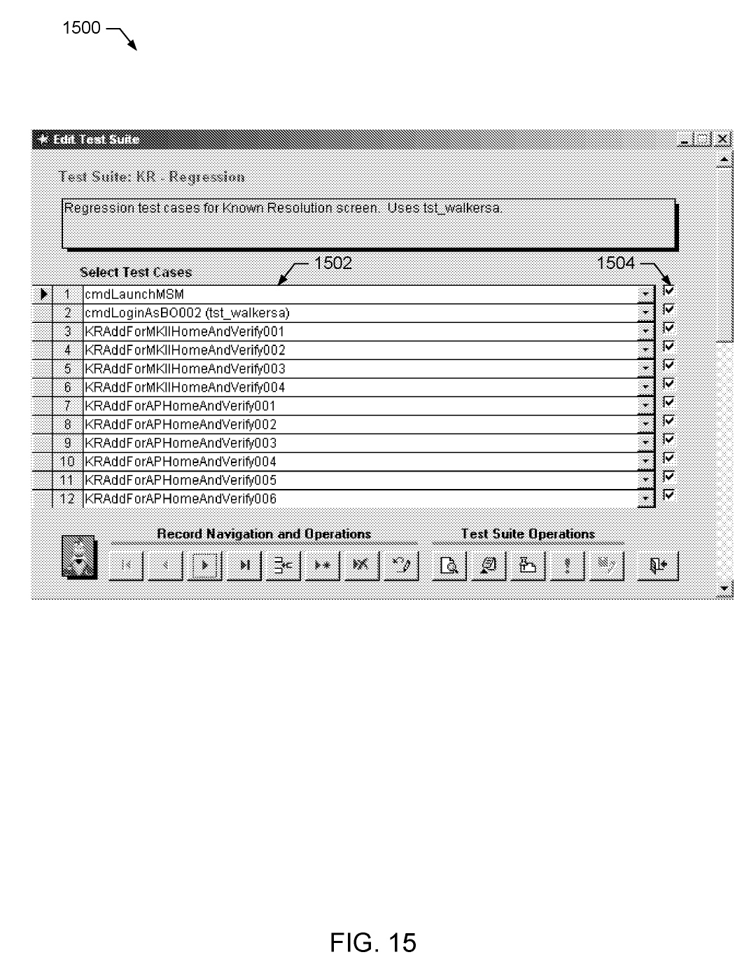

FIG. 15 illustrates an example test suite creation GUI 1500. The example test suite creation GUI 1500 allows a user to select test cases to be associated with a test suite using drop down menus 1502 and to indicate whether or not each test case should be processed or not using check boxes 1504.

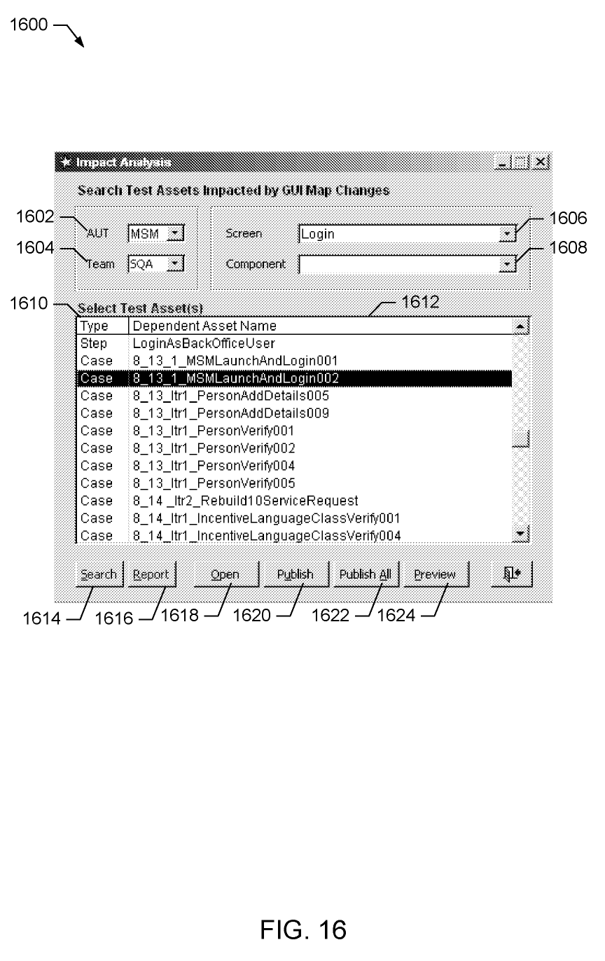

FIG. 16 illustrates an example impact analyzer GUI 1600 that may be used to provide a user interface to the impact analyzer 212 of FIG. 2. The example impact analyzer GUI 1600 allows a user to select an AUT using drop down menu 1602, to select a team (e.g., the team with which the user is associated such as, for example, a software validation team, an engineering design team, etc.) using drop down menu 1604, to select a GUI screen using drop down menu 1606, and to select a GUI element/component using drop down menu 1608. After a user has selected the screen and/or GUI element/component that is to be changed, the example impact analyzer GUI 1600 displays a list of test assets that will be affected by the change. For example, the impact analyzer GUI 1600 of the illustrated example displays the type (e.g., test step, test case, etc.) of the test asset that will be affected in column 1610 and displays the name of the test asset that will be affected by the change in column 1612. A user can use the search button 1614 to search for test assets (e.g., to search for a test assets whose name contains a word). A user can send a message (e.g., an electronic mail message) reporting the impact of GUI element changes using the report button 1616. A user can open a selected test asset for editing using the open button 1618, can publish the selected test asset which has been updated by the GUI change using the publish button 1620, can publish all test assets that have been updated by the GUI change using the publish all button 1622, and can preview updated test assets using the preview button 1624.

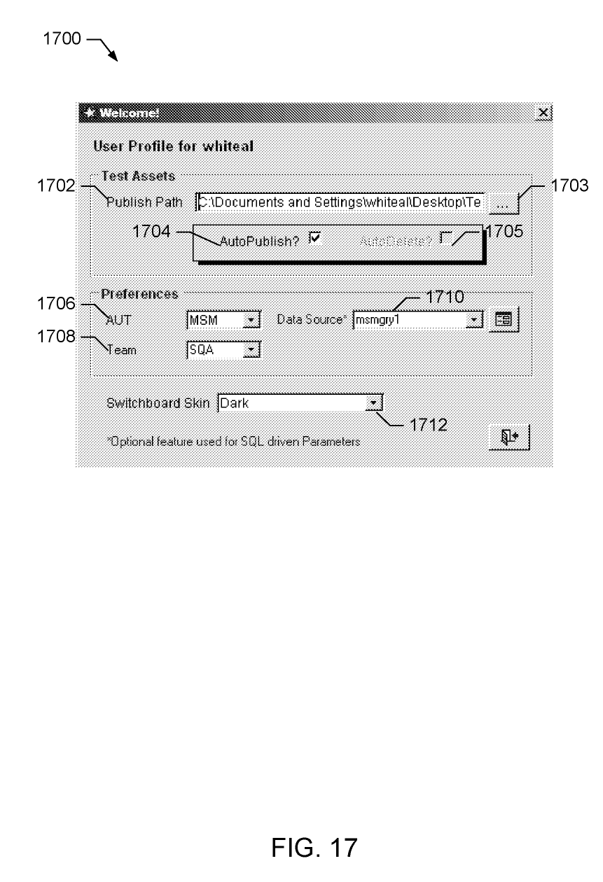

FIG. 17 illustrates an example user management GUI 1700 that may be used to provide a user interface to the user manager 214 of FIG. 2. In general, the user management GUI 1700 allows users and/or administrators of the test creator 110 to set the settings and preferences of users of the test creator 110. The example user management GUI 1700 allows a user and/or administrator to set a default file path to where test assets will be published using text box 1702 and browse button 1703, to indicate whether test assets should be automatically published as they are created and/or modified by a user using check box 1704, to indicate whether published test assets should be automatically deleted after they are modified or deleted in the test creator 110 using check box 1706, to indicate a preferred AUT (e.g., a default, a last used AUT, an AUT set by the administrator indicating that the user may only change the selected AUT, etc.) using drop down menu 1706, a team associated with the user using drop down menu 1708, a preferred data source (e.g., the external data source 108) using drop down menu 1710, and to select a default color scheme/skin for the user using drop down menu 1712.

FIG. 18 is a block diagram of an example computer 1800 capable of executing the machine readable implementing the processes illustrated in FIGS. 2, 3, 4, and 6 to implement the apparatus and methods disclosed herein.

The system 1800 of the instant example includes a processor 1812 such as a general purpose programmable processor. The processor 1812 includes a local memory 1814, and executes coded instructions 1816 present in random access memory 1818, coded instruction 1817 present in the read only memory 1820, and/or instructions present in another memory device. The processor 1812 may execute, among other things, machine readable instructions that implement the processes illustrated in FIGS. 2, 3, 4, and 6. The processor 1812 may be any type of processing unit, such as a microprocessor from the Intel® Centrino® family of microprocessors, the Intel® Pentium® family of microprocessors, the Intel® Itanium® family of microprocessors, and/or the Intel XScale® family of processors. Of course, other processors from other families are also appropriate.

The processor 1812 is in communication with a main memory including a volatile memory 1818 and a non-volatile memory 1820 via a bus 1825. The volatile memory 1818 may be implemented by Synchronous Dynamic Random Access Memory (SDRAM), Dynamic Random Access Memory (DRAM), RAMBUS Dynamic Random Access Memory (RDRAM) and/or any other type of random access memory device. The non-volatile memory 1820 may be implemented by flash memory and/or any other desired type of memory device. Access to the main memory 1818, 1820 is typically controlled by a memory controller (not shown) in a conventional manner.

The computer 1800 also includes a conventional interface circuit 1824. The interface circuit 1824 may be implemented by any type of well known interface standard, such as an Ethernet interface, a universal serial bus (USB), and/or a third generation input/output (3GIO) interface.

One or more input devices 1826 are connected to the interface circuit 1824. The input device(s) 1826 permit a user to enter data and commands into the processor 1812. The input device(s) can be implemented by, for example, a keyboard, a mouse, a touchscreen, a track-pad, a trackball, isopoint and/or a voice recognition system.

One or more output devices 1828 are also connected to the interface circuit 1824. The output devices 1828 can be implemented, for example, by display devices (e.g., a liquid crystal display, a cathode ray tube display (CRT), a printer and/or speakers). The interface circuit 1824, thus, typically includes a graphics driver card.

The interface circuit 1824 also includes a communication device such as a modem or network interface card to facilitate exchange of data with external computers via a network (e.g., an Ethernet connection, a digital subscriber line (DSL), a telephone line, coaxial cable, a cellular telephone system, etc.).

The computer 1800 also includes one or more mass storage devices 1830 for storing software and data. Examples of such mass storage devices 1830 include floppy disk drives, hard drive disks, compact disk drives and digital versatile disk (DVD) drives.

As an alternative to implementing the methods and/or apparatus described herein in a system such as the device of FIG. 18, the methods and/or apparatus described herein may alternatively be embedded in a structure such as processor and/or an ASIC (application specific integrated circuit).

Although certain example methods, apparatus, and articles of manufacture have been described herein, the scope of coverage of this patent is not limited thereto. On the contrary, this patent covers all methods, apparatus and articles of manufacture fairly falling within the scope of the appended claims either literally or under the doctrine of equivalents.

What is claimed is:

1. A method for testing software, the method comprising:
receiving from a software test engine a definition of a graphical user interface associated with an application;
receiving a user input indicating a test instruction associated with the graphical user interface associated with the application;
generating a test engine independent file including a first identifier associated with the graphical user interface associated with the application and a second identifier associated with the test instruction;
reading the first identifier and the second identifier from the test engine independent file; and
causing the software test engine to perform the test instruction associated with the second identifier using the first identifier.

2. A method as defined in claim 1, wherein the test engine independent file is a comma separated text file or an extensible markup language (XML) file.

3. A method as defined in claim 1, wherein the software test engine is one of the Rational Robot test engine from IBM, Mercury QuickTest Professional, Borland SilkTest, Ruby Watir, IBM Rational Functional Tester, or Mercury WinRunner.

4. A method as defined in claim 1, further comprising providing a second graphical user interface to allow a user to input the test instruction.

5. A method as defined in claim 1, further comprising:
receiving a change to at least one of the test instruction or the graphical user interface associated with the application; and
automatically overwriting the test engine independent file, in response to the change.

6. A method as defined in claim 1, further comprising:
receiving a user identifier from the user; and
determining which of a plurality of available applications is associated with the user based on the user identifier.

7. A method as defined in claim 1, further comprising receiving a request to execute the test instruction, wherein generating the test engine independent file, reading the first identifier and the second identifier, and causing the test engine to perform the test instruction are performed in response to the request.

8. A method as defined in claim 1, further comprising:
determining if the test instruction completed with a positive result; and
outputting a result value based on the determination.

9. A method as defined in claim 1, wherein the test engine independent file includes a reference to data stored in a database.

10. A method as defined in claim 9, further comprising retrieving the data from the database and causing the software test engine to perform the test instruction using the data retrieved from the database.

11. A method as defined in claim 1, further comprising displaying an image of the graphical user interface associated with the application.

12. A method as defined in claim 1, further comprising:
receiving a user identifier from a user;
restricting the user from generating the test engine independent file based on the user identifier.

13. A method as defined in claim 1, further comprising storing a reference to the application in a user profile.

14. (canceled)

15. A method for test software, the method comprising:
receiving a test engine independent file including a first identifier associated with a graphical user interface associated with an application and a second identifier associated with a test instruction;
determining an element of the graphical user interface associated with at least one of the first identifier or the second identifier;
determining an element type of the element;
selecting a function for performing a test associated with the second identifier and the element type;
performing the function; and
outputting a result value of the function.

16. A method as defined in claim 15, wherein the test engine independent file further includes an argument.

17. A method as defined in claim 16, wherein performing the function further comprises causing a software test engine to perform the function using the argument.

18. A method as defined in claim 15, wherein the element type is one of a button, a combo box, a text field, a text area, a radio button, a scroll bar a checkbox, a calendar control, a status bar, a table, a list box, a window, an image, a label, a tab, a menu item, or a toolbar.

19. A method as defined in claim 15, wherein the test engine independent file further includes a reference to data in a database.

20. A method as defined in claim 19, further comprising retrieving the data from the database.

21. An apparatus for testing software, the apparatus comprising:
an application including a graphical user interface;
a test creator to receive a definition of a graphical user interface associated with an application, to receive user input regarding a test instruction associated with the graphical user interface, and to output a test engine independent file based on the test instruction;
a test executor to receive the test engine independent file, to determine a function associated with the test engine independent file, and to execute the function.

22. An apparatus as defined in claim 21, further comprising a graphical user interface exporter to generate the definition of the graphical user interface and to send the definition of the graphical user interface to the test creator.

23. (canceled)

24. (canceled)

25. (canceled)

26. (canceled)

27. An apparatus as defined in claim 21, wherein the test executor comprises:
a graphical user interface receiver to receive the definition of a graphical user interface;
a database to store information associated with the definition of the graphical user interface;
a test asset creator to receive the test instruction from the user; and
a test asset publisher to output the test engine independent file based on the test instruction.

28. (canceled)

29. (canceled)

30. (canceled)

31. (canceled)

32. An apparatus as defined in claim 31, further comprising an impact analyzer to:
receive a change to at least one of the test instruction or the graphical user interface associated with the application; and
output a list of the test assets that are affected by the change to the test instruction or the change to the graphical user interface.

33. An article of manufacture storing machine readable instructions, which, when executed, cause a machine to:
receive from a software test engine a definition of a graphical user interface associated with an application;
receive a user input indicating a test instruction associated with the graphical user interface associated with the application;
generate a test engine independent file including a first identifier associated with the graphical user interface associated with the application and a second identifier associated with the test instruction;
read the first identifier and the second identifier from the test engine independent file; and
cause the software test engine to perform the test instruction associated with the second identifier using the first identifier.

34. (canceled)

35. (canceled)

36. (canceled)

37. (canceled)

38. An article of manufacture as defined in claim 33, wherein the machine readable instructions further cause the machine to:
receive a user identifier from the user; and
determine which of a plurality of available applications is associated with the user based on the user identifier.

39. (canceled)

40. (canceled)

41. (canceled)

42. (canceled)

43. (canceled)

44. (canceled)

45. (canceled)

46. (canceled)

47. (canceled)

48. (canceled)

49. (canceled)

50. (canceled)

51. (canceled)

52. (canceled)
